(19) United States
(12) Patent Application Publication
(10) Pub. No.: US 2011/0011483 A1
(43) Pub. Date: Jan. 20, 2011

(54) CERAMIC-OVERMOULDING METHOD AND COMPOSITE ELEMENT OBTAINED BY THIS METHOD

(75) Inventors: Francois Guillotin, Beaver Falls, PA (US); Aldo Ruffaldi, Kreaainem (BE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: N.C.A. TECHNOLOGIES

(21) Appl. No.: 12/746,496

(22) PCT Filed: Dec. 4, 2008
(86) PCT No.: PCT/EP08/66780

§ 371 Date: Sep. 30, 2010

(30) Foreign Application Priority Data
Dec. 4, 2007 (EP) 07122260.8

(51) Int. Cl. F16L 9/14; B29C 69/00

(52) U.S. Cl. 138/140; 264/638

(57) ABSTRACT

A member of an element for feeding fluid and pasty products in cylinder or sleeve form, able to withstand high thermal transitions, comprises, arranged concentrically relative to each other, a part made of ceramic material (6, 16) intended to come into contact with the fluid and a support made of polymer material (14, 22) overmoulded on the part made of ceramic material (6, 16). The part made of ceramic material (6, 16) has, on its external lateral face, at least one relief (24) comprising at least one dextrogyral helical groove and at least one levogyral helical groove that extend over the surface of the ceramic part in contact with the support made of polymer material which both prevent any relative movement of this part (6, 16) and of the support (14, 22), and distribute the tensions that can be produced by high temperature differentials.

### FIELD OF THE INVENTION

The invention relates to a method making it possible to manufacture composite ceramic elements especially suited to the handling and packaging of fluids or pasty or powdery products, in particular for the food, pharmaceutical and chemical industries.

The invention also relates to elements produced by such a method.

### STATE OF THE ART

The benefits of ceramic materials, of high technicality, are known: good hardness, mechanical strength, high resistance to wear and corrosion, low friction coefficient, low rate of salting-out of particles, low thermal expansion. Huge progress has also been made in the quality of the moulding, which makes it possible to produce pieces of unrivalled precision and surface state. On the other hand, ceramic is a brittle material and therefore very difficult to machine. Consequently, ceramic is frequently associated with a support material.

The applicant has thus specialized in the manufacture of feed elements, such as pumps, specially suited to the handling and packaging of fluids or pasty products in particular for the food, chemical and pharmaceutical industries. In these elements according to the state of the art, the ceramic for the pump elements in contact with the fluids, the powders or the pasty products is commonly associated with stainless steel, the latter being used for the jackets supporting the elements for joining the pumps with the other circuit elements (flanges, coupling elements, handles, etc.).

This association, despite its technical and technological benefits, is not without limitations. Despite the possibility of working with ever-smaller tolerances (of the order of a micrometre), below a certain scale it in fact becomes difficult to obtain an intimate contact between the two associated materials. Now, in the industries mentioned above it is vitally important to avoid the formation of interstices where deposits could be lodged and/or microorganisms could develop. The requirements of hygiene and purity have a direct impact on the production installations, which are also subject to restrictive and constantly changing legal regulations.

Efforts have therefore been made to associate ceramic with other materials, enabling a more intimate contact between the different components, and efforts have also been made to reduce the production costs. Particular efforts have been made to associate ceramic with polymer materials.

However, it appears that, in the case of elements for the fluid, powder or paste product packaging industries, the pieces need to be able to be cleaned, disinfected and sterilized, and it is necessary also to work at relatively low temperatures to avoid affecting the products to be packaged. Consequently, these feed elements are required to be able to undergo temperature transitions ranging, for example in the case of the food industry, from −10° C. to +140° C., which leads to stresses that can be qualified as “extreme” for such an association of materials. In practice, ceramics, unlike the polymer materials with which there is a desire to associate them, are distinguished by their very low expansion coefficient, evidence of the high tolerances that are demanded of them. Furthermore, the mechanical performance characteristics of polymer materials, in particular thermoplastics, are strongly degraded at high temperature.

US 2003/0171817 disclose femoral prostheses associating ceramic parts with polyethylene parts. Such a composite prosthesis, implanted in the human body, is never subject to great temperature differences.

Also known is FR-2683482 which describes tubular vessels such as glass or ceramic phials used in cosmetology, the stoppers of which, provided with diffusers, are joined to the neck by a sleeve of polymer material which is overmoulded onto this neck. The neck is also provided with axial and rotation-preventing securing reliefs intended to provide a better fixing for the sleeve on the neck. These axial and rotation-preventing fixing reliefs on the neck preferably consist of longitudinal reliefs (striations) and of an annular relief located below these longitudinal reliefs.

JP-2000/309031 describes an article comprising a body made of ceramic on which is overmoulded a polymeric disc. The surface of the cylinder in contact with the polymeric disc comprises a recess at the edges of which have been formed notches in order to increase the general resistance of the article described.

U.S. Pat. No. 4,309,937 describes a composite master cylinder comprising a cylindrical core made of metal or ceramic material on which is overmoulded a jacket made of plastic material. The surface of the cylindrical core in contact with the jacket is provided with annular grooves intended to secure the jacket and prevent any relative movement of the cylindrical core.

However, none of the articles described is intended to be subject to extreme temperature variations and therefore to excessive shear at the interface between the ceramic or metal part and the polymeric part due to high thermal expansion differences. Consequently, none of the articles described in the prior art is able to withstand extreme thermal gradients and/or mechanical stresses.

There is therefore still a need for composite ceramic elements specially adapted to the handling and packaging of fluids that are resistant to the thermal and mechanical stresses imposed, reliable, flexible, easy to maintain in suit and hygienic.

### SUMMARY OF THE INVENTION

One aim of the invention is to place on the market composite fluid packaging elements made of ceramic resistant to strong temperature differences, so as to be able to withstand, without problems, changes in temperatures between processing conditions (around the freezing point of water) and in situ cleaning, and in particular sterilization, conditions (above 100° C.)

Another aim of the invention is for these composite pieces to be without interstices, without needing sealing devices.

Another aim of the invention is for these pieces to benefit from a long life.

Another aim of the invention is for these pieces to be able to be used in methods of manufacturing food, pharmaceutical or chemical products.

The subject of the invention is a member of a composite element for feeding fluids and pasty or powdery products having an outer surface that is substantially cylindrical able to withstand thermal gradients and/or mechanical stresses. This member comprises, arranged concentrically relative to each other:
a part made of ceramic material designed to come into contact with the fluid, having an outer surface that is substantially cylindrical,
a support made of polymer material overmoulded on the part made of ceramic material.

The part made of ceramic material has, on its external lateral face, at least one relief preventing any relative movement of this part and of the support and distributing the tensions generated by the difference between the expansion coefficients of the ceramic and polymer materials, this at least one relief comprising at least one dextrogyral helical groove and at least one levogyral helical groove extending over the surface of the ceramic part in contact with the support made of polymer material.

This at least one relief comprising at least one dextrogyral helical groove and at least one levogyral helical groove distributes the tensions created by the difference between expansion coefficients of the ceramic and polymer materials both in operation and during the cleaning steps. It will be noted that, depending on the embodiment, the polymer material may possibly come into contact with the product conveyed and it must therefore satisfy both resistance and hygiene criteria.

According to a first advantageous embodiment, the part made of ceramic material is a female piece in the form of a sheath, the support made of polymer material forming a jacket overmoulded on the external lateral face of this sheath made of ceramic. This member is, for example, a pump body or an insert.

According to another advantageous embodiment, the part made of ceramic material is a male cylindrical piece. The support made of polymer material forms a jacket covering one of the ends of the external lateral face of this cylindrical piece. This member is, for example, a piston.

According to another advantageous embodiment, the relief further comprises at least one groove extending radially over the external lateral surface of the cylindrical piece. According to a preferred embodiment, this at least one peripheral groove is arranged close to at least one of the ends of the surface of the part made of ceramic in contact with the support made of polymer material.

The relief has, according to a preferred embodiment, a depth of between 0.25 and 0.40 mm.

According to a preferred embodiment, the relief extends over most of the surface of the ceramic part in contact with the support made of polymer material.

According to an advantageous embodiment, the relief is produced by machining.

The ceramic material is preferably chosen from the group comprising [alumina, zirconia, silicon nitride and their compounds, such as Sialon®, etc.]

The polymer of the support is advantageously chosen from the group comprising [PPS, PPSU, PSU, PEEK, PEI, PES, PVDF and others].

At least one end of the part made of ceramic in contact with the support made of polymer material, is, advantageously, chamfered.

Another subject of the invention is a method of manufacturing a member of a composite element for feeding fluid, pasty or powdery product having an outer surface that is substantially cylindrical able to withstand strong thermal gradients and/or mechanical stresses. This method comprises the following operations:
preparation of a mixture of appropriate composition to obtain, after baking, a ceramic material suitable for machining. This mixture, of pasty consistency, generally comprises mineral powders and binders;
Preparation of a proof piece having an outer surface that is substantially cylindrical by moulding or extruding this mixture;
prebaking of this proof piece at low temperature (generally of the order of 600°);
Rough-turning of this proof piece;
production of at least one relief comprising at least one dextrogyral helical groove and at least one levogyral helical groove extending over an external lateral surface of this proof piece;
High-temperature sintering of this proof piece, so as to obtain a cylindrical ceramic element to the tolerances demanded of the final piece and of suitable dimensions;
preheating of this ceramic element to a temperature compatible with the contact of a polymer material;
Placement of this ceramic element in a preheated overmoulding mould;
Injection into the overmoulding mould of a polymer material; and
Cooling and extraction of the composite piece obtained from the overmoulding mould.

According to a preferred embodiment, this method also comprises an annealing of the composite piece obtained by overmoulding.

According to a preferred embodiment, the grooving of the ceramic element is produced by machining after pre-baking. However, all or part of this grooving can also be prepared during moulding or after sintering the element.

Other particular features and advantages of the invention will be clarified in the detailed description of particular embodiments of the invention given hereinbelow, with reference to the figures, in which:

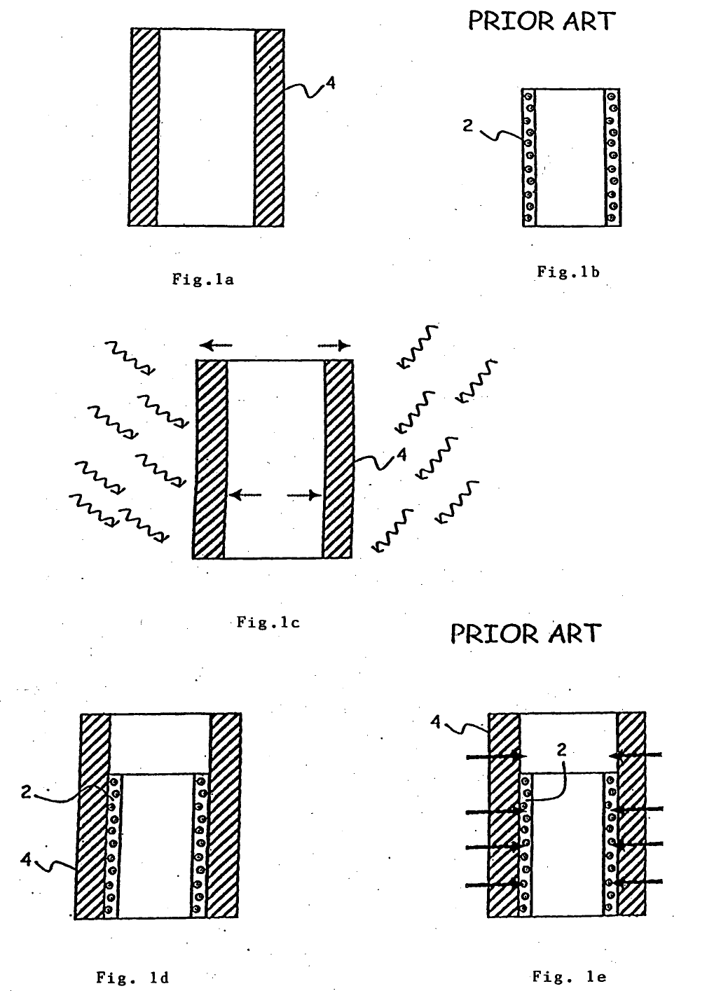

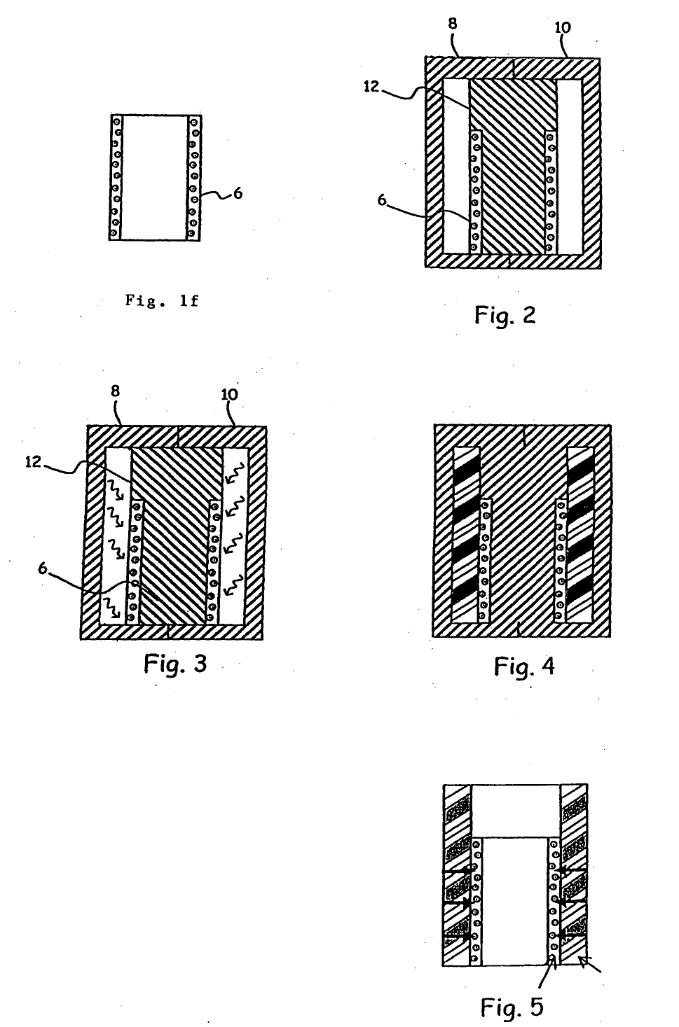

FIGS. 1a to 1e are cross-sectional diagrammatic views of different steps of the sintering method used in the prior art to assemble ceramic and metallic elements;

FIG. 1f to 5 are cross-sectional diagrammatic views of different steps of the overmoulding method according to the invention making it possible to sustainably associate ceramic and polymer elements in the case of female structures;

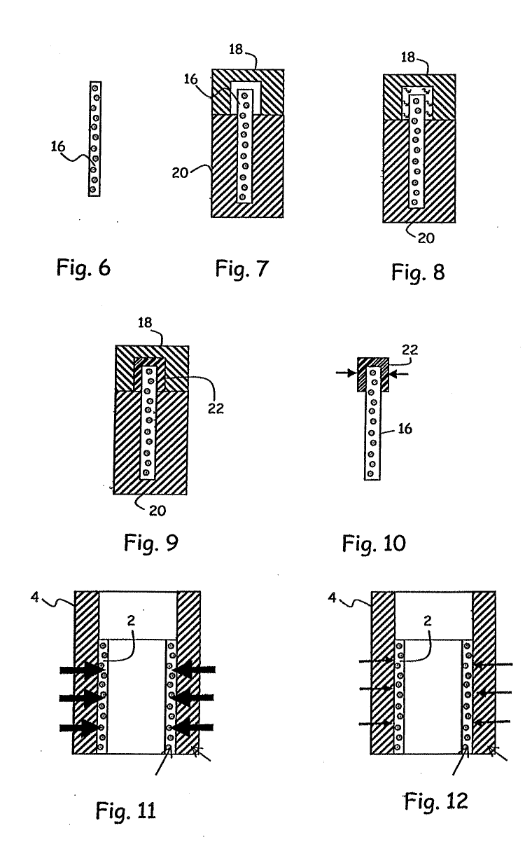

FIGS. 6 to 10 are views similar to the views 1 to 5 in the case of male structures;

FIGS. 11 and 12 are cross-sectional views comparing reciprocal stresses being exerted on the ceramic elements in the case, of hooping and in the case of overmoulding.

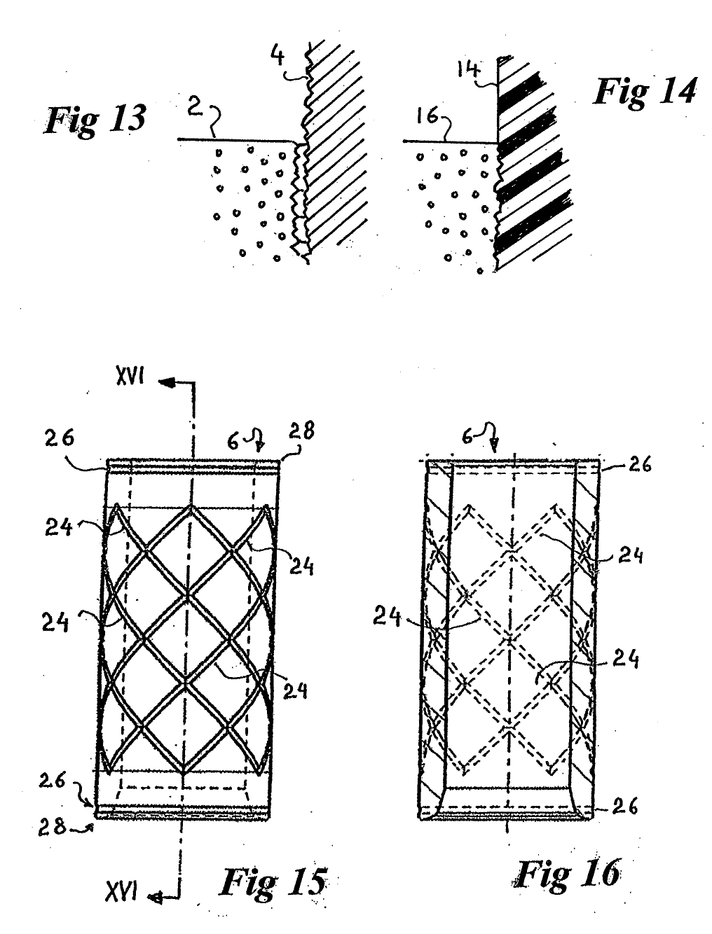

FIGS. 13 and 14 are cross-sectional diagrammatic views of a detail respectively of FIGS. 11 and 12;

FIG. 15 is a view in elevation of a female ceramic element used for the overmoulding method according to the invention;

FIG. 16 is a cross-sectional view along the plane XVI-XVI of the element of FIG. 15.

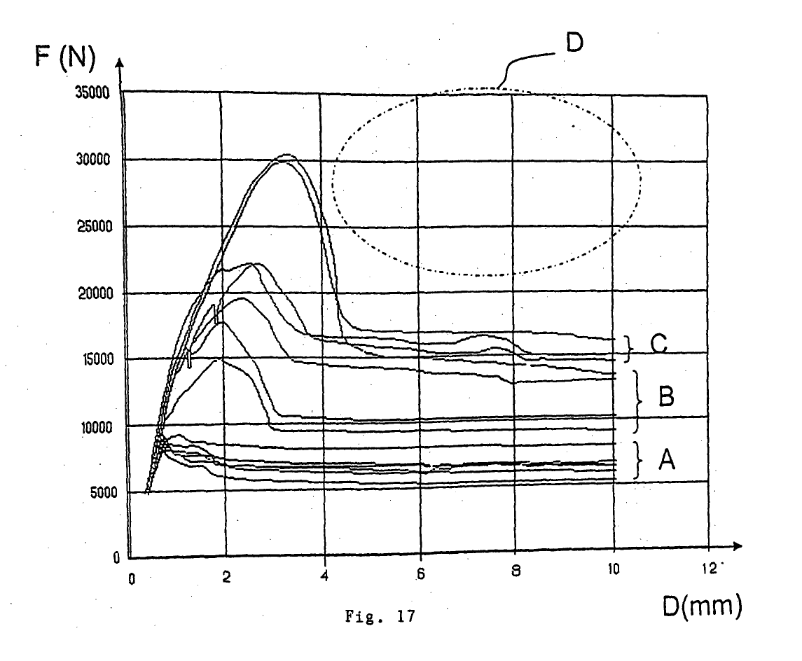

FIG. 17 is a graph showing the relationship between the depth of the grooves and the tear resistance of the polymer-ceramic interface.

The figures are not drawn to scale. Generally, like elements are denoted by similar references in the figures.

### DETAILED DESCRIPTION OF PARTICULAR EMBODIMENTS

FIGS. 1a to 1e give the various steps of the hooping method developed previously (prior art) for assembling ceramic and metallic elements to produce composite pieces that can satisfy the constraints imposed by the packaging industries.

FIG. 1b shows an element in sleeve form made of ceramic 2, defined as a “female” element. The qualities of the ceramic makes such an element ideal for forming the internal sleeve of a pump chamber for the packaging of fluids, pasty or powdery products. However, as such, this sleeve is virtually unusable, since it is excessively difficult to join it to other pieces of a circuit without risk of damaging it. One solution is to set it in a cylinder make of stainless steel 4, as represented in FIG. 1d. This cylinder 4 can be provided, by different known methods (welding, brazing, moulding), with various added accessories (not shown, in the interests of clarity). This cylinder 4 is machined internally so that its internal diameter roughly corresponds to the diameter of the sleeve 2. It is heated, so as to increase its diameter (FIG. 1c), and the sleeve is inserted therein (FIG. 1d). After cooling, the retraction of the diameter of the cylinder 4 holds the sleeve made of ceramic 2 firmly in place (FIG. 1e). The heating conditions, the composition of the metal, the temperature, etc., are obviously calculated so as to obtain an optimal joining of the two components.

The inventive overmoulding method is shown with reference to FIG. 1f to 5. After manufacturing according to the method described previously, the sleeve made of ceramic 6 according to the invention (FIG. 1f) is first preheated, so as to reach a temperature compatible with the injection of a selected polymer material. This preliminary step is important because the temperature difference between the different elements, including the temperature of the polymer and that of the mould elements, can lead to the creation of tensions within the material. The sleeve is then placed in a steel injection mould that is in two parts 8, 10, which has also previously been preheated (FIG. 2), after having been threaded onto a metal core 12 (FIG. 3).

A polymer material is injected into the gap between the two parts of the mould 8, 10, the core 12 and the sleeve 6 (FIG. 4). FIG. 5 represents the sleeve 6 in the terminal state: the polymer material is cooled and shrunk, and forms a jacket 14 which exerts on the ceramic sleeve 6 a pressure that intimately joins the two elements. To dissipate some of the tensions generated in moulding, an annealing of the composite piece is generally carried out at this stage, which is in itself an unusual operation for polymers. There is now a composite element capable of withstanding high thermal stresses without being deformed, which can be used for example as a chamber for a feed pump, as a coupling element (insert), as a body for a drinks distributor, etc.

FIGS. 6 to 10 show that the method applies equally to male cylindrical elements. Here, a solid cylinder made of ceramic 16 is used. This cylinder 16, after having been preheated (FIG. 6), is placed in a preheating mould (FIG. 7), in this case formed by two parts 18, 20, which leaves a void around one of the ends of the cylinder 16 (FIG. 8). A polymer material is injected into the mould (FIG. 9). After cooling and removal from the mould, the end of the cylinder 16 is now fitted with a sheath 22 (FIG. 10), which makes it possible, after an annealing as described previously, to use it among other things as a piston for a pump body manufactured as shown in FIG. 1f to 5. The two elements of the piston are joined both by adhesion and by the pressure due to the shrinkage of the sheath 22 around the cylinder 16.

Obviously, the moulds, here represented in two parts, can in practice comprise an indeterminate number of fitted or moving parts, depending on the complexity of the piece (jacket 14, sheath 22) to be produced.

FIGS. 11 and 12 highlight one of the crucial problems faced by those skilled in the art on changing from the hooping-based joining method the overmoulding-based joining method: in the case of hooping (FIG. 11), it is “sufficient”, in the preheating step shown in FIG. 1c, to choose a temperature far greater than the maximum operating temperature of the composite piece to eliminate any danger of separation between the sleeve 2 and its jacket 6. On the express condition, obviously, that the sleeve 2 and the jacket 4 are designed so as to permanently withstand the pressure exerted by the interface. Moreover, the metal of the jacket is generally chosen to present an expansion coefficient that is as low as possible to bring it as close as possible to the characteristics of the ceramic.

In the case of overmoulding (FIG. 12), there is a significantly more complex problem. Although an excellent adhesion coefficient is observed between the sleeve 6 and the jacket 14, the pressure exerted by the polymer material on the sleeve is infinitely less, and above all, the shear resistance of a polymer material bears absolutely no resemblance to that of a metal.

A macroscopic scale view of the ceramic-metal and ceramic-polymer interfaces of FIGS. 11 and 12 is represented in FIGS. 13 and 14. In the case of hooping (FIG. 13), the surfaces in contact have roughnesses and irregularities which obviously help to improve the joining between the two pieces, but also delimit an interstice into which residues and impurities can slip. In the case in particular of the pharmaceutical or food industry, these interstices constitute genuine microbe breeding grounds, which can be avoided only by the addition of seals or filling materials, solutions to be avoided because they are often precarious or unreliable. In the case of overmoulding (FIG. 14), the polymer material itself forms the repointing means, and flawless hygiene is assured as long as the two pieces remain joined.

The solution lies both in a wise choice of the facing materials and in the non-obvious production of a particular ceramic-polymer interface, one exemplary embodiment of which is shown in FIGS. 15 and 16.

Since the simple juxtaposition of the materials would inevitably lead to tensions and relative movements within composite pieces, a choice has been made to provide on the interface reliefs which, on the one hand, prevent any relative movement and, on the other hand, distribute the tensions generated sufficiently uniformly to avoid the separation of the pieces and the appearance of cracks.

According to the invention, and as represented in FIGS. 15 and 16, after having undergone a pre-bake, the piece made of ceramic 6 has been machined so as to provide a series of reliefs along its external wall. These reliefs extend both in the longitudinal direction and in the radial direction thus forming spiral grooves 24. According to the invention, some of these grooves 24 are dextrogyral, others levogyral, so as to form an interlacing along almost all the part of the wall intended to come into contact with the overmoulded jacket.

The role of these grooves is, obviously, to ensure the reciprocal joining of the elements 6 and 14, but above all, as explained above, to distribute the forces being exerted in the polymer material because of tensions generated by the differences between the expansion coefficient of the ceramic and of the polymer material, and by the temperature gradients observed.

In the context of the present invention, the applicant has surprisingly discovered that this at least one relief comprising at least one dextrogyral helical groove and at least one levogyral helical groove is capable of distributing particularly effectively the tensions created by the difference between the expansion coefficients of the ceramic and polymer materials.

According to the preferred embodiment of the invention represented in FIG. 15, the piece made of ceramic 6 also includes the presence of peripheral grooves 26 provided close to the ends of the sleeve.

Both the resistance to thermal shocks and the tear resistance of a ceramic-polymer composite element have been measured on test pieces for different groove geometries (24 and 26), for different groove depths, for different groove densities (number of grooves per cm) and for different sorts of polymers, and also in the absence of any network of grooves.

The results of the tear resistance tests, which can be seen in FIG. 17, have made it possible to demonstrate that in the absence of grooving or for grooves that do not exceed 0.10 mm (curves A), a rapid separation of the two components and/or the appearance of cracks in the polymer, proof of the presence of very localized tensions, are observed. More importantly, the results of FIG. 17 show that, when the grooves are of helical type according to the invention (curves C), that is comprising at least one dextrogyral helical groove and at least one levogyral helical groove, the resistance to shedding between the two components is high (low relative displacement, measured in millimetres, with force in newtons), whereas in the case of circular type grooves (curves A and B), relatively rapid separation of the two components is observed.

Moreover, it has been observed that deepening grooves to 0.25 (curves B) or even 0.40 mm (curves C), and increasing their density also has positive effects: the two materials remain perfectly joined. The beneficial effect of deepening the grooves and increasing their density is not, however, unlimited: beyond a critical threshold (domain D), increasing the dimensions of the grooves leads to the appearance of spurious phenomena (excessive thickness of the polymer film giving rise to non-uniformities, incomplete filling of the grooves), which degrade the results.

The analysis of the tensions also shows a paradoxical effect, which does, however, corroborate the present analysis: the presence of sharp corners at the ceramic-polymer interface, which favours the relative immobilization of the components (as shown in U.S. Pat. No. 4,309,937) is far from being a cause, as might reasonably have been expected, of favourable effects. On the contrary, it has unfavourable effects, because it leads to a concentration of the stresses in the polymer around these sharp corners, which degrades the observed performance characteristics. Care has therefore been taken, when moulding the grooves and all the parts of the interface, to provide fillets, rounded edges or chamfers 28—as far as possible—for each transition between two surfaces.

It would be thought that the machining of pieces made of ceramic, a material that is particularly hard, brittle and fragile, is a solution that would not come spontaneously to those skilled in the art, and that the solution adopted is therefore anything but evident.

Moreover, it will appear evident to those skilled in the art that the present invention is not limited to the examples illustrated and described hereinabove. The present invention has been described in relation to specific embodiments, which have a purely illustrative value and should not be considered to be limiting.

It will be noted in particular that the shaping of the reliefs of the interface, produced here by machining at the rough-turning stage, could possibly be produced at the moulding stage, and/or at least complemented by machining after final bake. In practice, however, the shaping of the part made of ceramic by moulding means a relatively high investment, because it is necessary to use a complex mould comprising a large number of moving pieces. Moreover, it is essential to take account of the intermediate operation for grinding the pre-baked proof piece. Such an investment would be cost-effective only if a very large number of identical pieces were to be produced, which is not common in the field concerned. The preparation of the reliefs after grinding makes it possible to avoid working on an extremely hard material, which requires a lengthy machine time, which is obviously very costly, but account must be taken of the fact that, although there are diamond-tipped tools available for use, the proof piece is at this moment very fragile and the number of scrapped pieces is relatively high.

1. Member of a composite element for feeding fluid, pasty or powdery product having an outer surface that is substantially cylindrical able to withstand thermal gradients and/or mechanical stresses that comprises, arranged concentrically relative to each other:
A part made of ceramic material (6, 16) designed to come into contact with the fluid, having an outer surface that is substantially cylindrical,
A support made of polymer material (14, 22) overmoulded on the part made of ceramic material (6, 16),
characterized in that the part made of ceramic material (6, 16) has, on its external lateral face, at least one relief (24) preventing any relative movement of this part and of the support and distributing the tensions generated by the difference between the expansion coefficients of the ceramic and polymer materials, this at least one relief (24) comprising at least one dextrogyral helical groove (24) and at least one levogyral helical groove (24) extending over the surface of the ceramic part in contact with the support made of polymer material.

2. Member according to claim 1, characterized in that the part made of ceramic material (6, 16) is a female piece (6) in the form of a sheath, the support made of polymer material forming a jacket (14) overmoulded on its external lateral face of this sheath (6) made of ceramic.

3. Member according to claim 2, characterized in that this member is a pump body or an insert.

4. Member according to claim 1, characterized in that the part made of ceramic material (6, 16) is a male cylindrical piece (16), the support made of polymer material forming a jacket (22) covering one of the ends of the external lateral face of this cylindrical piece (16).

5. Member according to claim 4, characterized in that this member is a piston.

6. Member according to any one of the preceding claims, characterized in that it also comprises at least one peripheral groove (26) arranged close to at least one of the ends of the surface of the part made of ceramic in contact with the support made of polymer material.

7. Member according to any one of the preceding claims, characterized in that the at least one relief (24) is formed by machining, with the removal of material.

8. Member according to any one of the preceding claims, characterized in that the at least one relief (24) has a depth of between 0.25 and 0.40 mm.

9. Member according to any one of the preceding claims, characterized in that the ceramic material is chosen from the group comprising [alumina, zirconia, silicon nitride, and their compounds].

10. Member according to any one of the preceding claims, characterized in that the polymer of the support is chosen from the group comprising [PPS, PPSU, PSU, PEEK, PEI, PES, PVDF].

11. Member according to any one of the preceding claims, characterized in that at least one end of the part made of ceramic (6, 16) in contact with the support made of polymer material is chamfered.

12. Method of manufacturing a member of a composite element for feeding fluid, pasty or powdery product having an outer surface that is substantially cylindrical able to withstand thermal gradients and/or mechanical stresses, characterized in that it comprises the following operations:
Preparation of a mixture of appropriate composition to obtain, after baking, a ceramic material suitable for machining;
Preparation of a proof piece having an outer surface that is substantially cylindrical by moulding or extruding this mixture;
Prebaking of this proof piece at low temperature;
Rough-turning of this proof piece;
Production of at least one relief (24) comprising at least one dextrogyral helical groove and at least one levogyral helical groove extending over the external lateral surface of this proof piece;
High-temperature sintering of this proof piece, so as to obtain a ceramic element (6, 16) of suitable dimensions;
Preheating of this ceramic element to a temperature compatible with the contact of a polymer material;
Placement of this ceramic element in a preheated overmoulding mould;
Injection into the overmoulding mould of a polymer material; and
Cooling and extraction of the composite piece obtained from the overmoulding mould.

13. Manufacturing method according to claim 12, characterized in that the production of reliefs on the external lateral surface of the ceramic element is produced by machining when the proof piece is rough-turned, after prebaking at low temperature.

14. Manufacturing method according to one of claims 12 or 13, characterized in that it also comprises the operation for annealing the composite piece obtained by overmoulding.

15. Manufacturing method according to one of claims 12 to 14, characterized in that the reliefs are preformed at the moulding stage and/or machined after sintering at high temperature.
